(19) United States
(12) Patent Application Publication
(10) Pub. No.: US 2012/0116614 A1
(43) Pub. Date: May 10, 2012

(54) METHOD AND APPARATUS FOR AIR TRAFFIC TRAJECTORY SYNCHRONIZATION

(75) Inventors: Sergio TORRES, Bethesda, MD (US); Joel Klooster, Grand Rapids, MI (US)

(73) Assignee: LOCKHEED MARTIN CORPORATION, Bethesda, MD (US)

(21) Appl. No.: 13/292,685

(22) Filed: Nov. 9, 2011

Related U.S. Application Data
(60) Provisional application No. 61/411,628, filed on Nov. 9, 2010.

(51) Int. Cl. G05D 1/00

(52) U.S. Cl. 701/3

(57) ABSTRACT

According to aspects of the embodiments, there is provided an apparatus and method to synchronize the distinct trajectories predicted by a flight management system and air navigation service provider. A comparison model is generated that indicates differences between an aircraft trajectory and a ground trajectory. The aircraft trajectory is updated to reflect identified discrepancies and restriction violations between the trajectories. Upon successful completion of the first designated change, a notification manager is used to issue a notification of the designated change to the flight plan trajectory. A modified ground trajectory is produced that incorporates the designated change to the flight plan trajectory. The comparison is repeated until the discrepancies of the trajector [symbol] insignificant.

### CROSS-REFERENCES TO RELATED APPLICATIONS

This application claims priority to U.S. Provisional Application No. 61/411,628, entitled “METHOD AND APPARATUS FOR AIR TRAFFIC TRAJECTORY SYNCHRONIZATION,” filed Nov. 9, 2010, by Sergio TORRES et al, the entire disclosure of which is incorporated herein by reference in its entirety.

This application is related to the following co-pending applications, which is hereby incorporated by reference in its entirety: “METHOD AND APPARATUS FOR DYNAMIC AIR TRAFFIC TRAJECTORY SYNCHRONIZATION”, Attorney Docket No.: 036-0085-P, U.S. Provisional Application No. 61/542,071, filed on 30 Sep. 2011, by David S. CHAN et al.

### BACKGROUND

1. Field of the Disclosed Embodiments

The disclosure relates to air traffic trajectory synchronization, in particular to the synchronizing of distinct trajectories predicted by a plurality of systems.

2. Introduction

In trajectory based operations (TBO), air-ground and ground-ground interoperability and trajectory synchronization among the various systems is required since each of these systems rely on an accurate prediction of the flight path in four dimensions (4D trajectory or 4DT). Without proper synchronization, the Air Traffic Control (ATC) and Air Traffic Management (ATM) of the airspace is forced to add significant uncertainty into its prediction of the aircraft trajectory, thus decreasing the potential capacity of the available airspace and the efficiency of operations. The uncertainty that results from air-ground and ground-ground trajectory discrepancies also leads to non-optimal tactical intervention. The goal of air-ground (or ground-ground) trajectory synchronization is to produce trajectories in disparate systems whose discrepancies are operationally insignificant, increasing the likelihood of flying the planned conflict-free and business-preferred trajectories. In addition, if conditions change in the ground requiring alternative trajectories (i.e., projecting for conflict resolution or schedule management, for instance), then the ATC/ATM systems have to be able to independently build new trajectories that are compatible with user preferences and with the requirements of the Flight Management System (FMS) on board the aircraft.

In the field of flight management systems (FMSs), the technical problem to be solved is related to the use by the ground of predictions calculated by the FMS along the flight plan (location, altitude, speed, fuel, time of passage, for each point on the flight plan). In recent studies, it emerged that a significant improvement in capacity and safety for future ATM systems lay on the one hand in the collaboration between the Air Navigation Service Provider (ANSP) and onboard (aircraft) operators, in particular the synchronization of route and flight data, and on the other hand in the accuracy of the predicted trajectories.

The ground-based operators and supporting automation tools can use the predictions issued by aircraft to organize the traffic, balance the traffic load among each control sector, anticipate the dynamic control sector segmentations and groupings, sequence the aircraft more effectively in the terminal procedures, and lastly be able to deploy an end-to-end ATM system (“4D” and “Gate to Gate” concepts).

All these operations require both regular synchronization and precision in trajectory forecasts carried out on the ground and on board. One of the main challenges to Trajectory Based Operations (TBO) is interoperability and coordination among systems (air-ground and ground-ground). It is foreseen that a primary means to respond to this

Challenge is to provide a common view of operations as provided by synchronized trajectories. 4DTs provide the basis for both strategic planning and tactical operations, and as such they are key enablers of TBO. On board the aircraft, the FMS uses a trajectory for closed-loop guidance by way of the automatic flight control system (AFCS). In ground systems, the trajectory provides the information that is required for planning and for performing critical air traffic control and traffic flow management functions, such as: scheduling, conflict prediction, intra-sector hand off, separation management and conformance monitoring. With such a vast range of uses, the unique set of trajectory requirements (which at times may be contradictory) applicable to each function cannot be met in an efficient manner by simply sharing a common trajectory. A trajectory used to guide the aircraft requires a different level of fidelity than a trajectory used to estimate sector load in the ground a few hours into the future.

Previous studies identified various Trajectory Synchronization approaches, including: Flight Intent synchronization, Aircraft Intent (AI) synchronization, Behavior Model synchronization, Predicted Trajectory synchronization. Flight intent is primarily the information carried by the flight plan but it is insufficient for accurate synchronization because it does not contain enough information to build from it an unambiguous rendition of the flight path in 4D (i.e. multiple dissimilar trajectories can be generated from the same flight plan). Aircraft intent-based trajectory synchronization relies on using the FMS provided AI so it lacks all of the knowledge available by the ground system. Behavior Model data consists of a list of the maneuvers that the aircraft needs to execute in order to follow the flight plan, thus it is similar to aircraft intent data except that the information is expressed more abstractly. Synchronization using aircraft intent or behavior model data does not account for differences in weather forecast models and aircraft performance models, therefore could result in significantly different 4D predictions. The last approach, Predicted Trajectory synchronization consists of down-linking the FMS predicted 4D trajectory (for example via Automatic Dependent Surveillance-Contract (ADS-C) Extended Projected Profile (EPP) reports) and using it “as is” by the ground systems. This approach is limited by the fact that the FMS 4D trajectory is a prediction for current conditions and constraints only, and if conditions change in the ground that require building alternative trajectories the FMS 4D-trajectory has to be discarded and a completely new trajectory has to be built on the ground system, opening the possibility for breaking synchronization.

For the reasons stated above, and for other reasons stated below which will become apparent to those skilled in the art upon reading and understanding the present specification there is need in the art for a system and method that synchronizes trajectories from disparate systems.

### SUMMARY

According to aspects of the embodiments, there is provided an apparatus and method to synchronize the distinct trajectories predicted by a flight management system and air navigation service provider. A comparison model is generated that indicates differences between a Flight Management System (FMS) trajectory and a ground trajectory. A new synchronized trajectory is generated that resolves identified discrepancies and restriction violations between the trajectories. The synchronized trajectory is built first by resolving discrepancies in the converted route of flight (the 2D path along the Latitude and Longitude dimensions) and then, once 2D differences have been resolved, altitude and speed restriction compliances is verified. Upon successful resolution of 2D path discrepancies and restriction compliance violations, the synchronized trajectory is build by using the FMS trajectory as the basis.

### BRIEF DESCRIPTION OF THE DRAWINGS

FIG. 1 illustrates a practical application in accordance to an embodiment;

FIG. 2 is a block diagram of a hardware and operating environment in which different embodiments can be practiced;

FIG. 3 transaction flow diagram illustrating the manner in which the flight management system (FMS) and ATC computer of FIG. 1 cooperate to perform trajectory synchronization and exchange of data relating to a flight plan trajectory in accordance to an embodiment;

FIG. 4 is a block diagram of a pre-departure trajectory synchronization in accordance to an embodiment;

FIG. 5 is a block diagram of a in-flight trajectory synchronization in accordance to an embodiment; and

FIG. 6 is a flowchart of a method for trajectory synchronization in accordance to an embodiment.

### DETAILED DESCRIPTION OF THE DISCLOSED EMBODIMENTS

Additional features and advantages of the disclosure will be set forth in the description which follows, and in part will be obvious from the description, or may be learned by practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Aspects of the disclosed embodiments relate to a method for trajectory synchronization comprising receiving a first trajectory from any system (but to facilitate the discussion it will be referred to as the aircraft trajectory, and could be for instance the 4D trajectory generated by the FMS on board the aircraft) and a ground trajectory from a second system comprising a series of points associated with various flight constraints for an aircraft; comparing the aircraft trajectory and the ground trajectory to detect discrepancies; verifying from the aircraft trajectory that a proposed flight plan complies with at least one aircraft restriction; and sending a message to the first system with instruction for correcting identified discrepancies and restriction violations from the comparing and the verifying of the aircraft trajectory and the ground trajectory.

In yet another aspect the disclosed embodiments the method further comprises receiving from the first system a four-dimensional trajectory comprising correction of the identified discrepancies and restriction violations.

In yet another aspect the disclosed embodiments the method further comprises receiving an updated ground trajectory after processing of the four-dimensional trajectory from the first system by the second system.

In yet another aspect the disclosed embodiments the method further comprises reconforming the updated ground trajectory if the aircraft has received a departure message or if the aircraft has received a sector crossing message (such as entry into the controlled airspace).

In yet another aspect the disclosed embodiments the method further comprises monitoring and updating the updated ground trajectory and the aircraft trajectory based on information pertaining to at least one of ground changes, change in environmental conditions.

In yet another aspect the disclosed embodiments wherein comparing the aircraft trajectory and the ground trajectory to detect discrepancies is based on detecting discrepancies in latitude and longitude information.

In yet another aspect the disclosed embodiments the method further comprises wherein comparing is achieved with a cusp-to-cusp differencing algorithm (where a trajectory cusp or trajectory change point is any of the points defining the trajectory data structure).

In yet another aspect the disclosed embodiments wherein the at least one aircraft restriction is selected from the group consisting of altitude restriction and speed restriction.

Still another aspects of the disclosed embodiments relate to a system for synchronizing distinct trajectories in airspace, the system comprising: a computer executing an interface to receiving an aircraft trajectory from a first system and a ground trajectory from a second system comprising a series of points associated with various flight constraints for an aircraft; and a processor and a memory coupled to the processor, wherein the memory comprises program instructions executable by the processor to: comparing the aircraft trajectory and the ground trajectory to detect discrepancies; verifying from the aircraft trajectory that a proposed flight plan complies with at least one aircraft restriction; wherein the computer executes a notification manager to send a message to the first system with instruction for correcting identified discrepancies restriction violations from the verifying and the comparing of the aircraft trajectory and the ground trajectory.

In still yet another aspect of the disclosed embodiments relate to a non-transitory computer-readable medium having instructions that when compiled by a processor perform trajectory synchronization from a plurality of systems comprising: a computer-usable data carrier storing instructions, the instructions when executed by a computer causing the computer to perform trajectory synchronization by: comparing the trajectories to verify at least one route agreement for an aircraft; verifying from the trajectories that a proposed flight plan complies with at least one aircraft restriction; and

Sending a message to at least one of the plurality of systems with instruction for correcting identified discrepancies and restriction violations from the verifying and the comparing of the trajectories.

The term “operator” as used herein refers to an airline, a cargo operator, a business jet operation, or the pilot in single pilot operations.

The term “communication”, or “message” as used herein refers communications through Automatic Dependent Surveillance-Contract (“ADS-C”), Controller Pilot Data Link Communications (“CPDLC”), ARINC devices, radio frequency devices, microwave devices, and/or the like.

Provided below is an example of acronyms found in trajectory synchronization: Air Traffic Management (ATM); Flight Management System (FMS); Air Traffic Control (ATC); En Route Automation Modernization (ERAM); Common Automated Radar Terminal System (Common ARTS); Trajectory Based Operations (TBO); Air Navigation Service Provider (ANSP); US Next Generation Air Transport System (NextGen); Single European Sky ATM Research (SESAR); 4D Trajectory for Data Link (4DTRAD); automatic flight control system (AFCS); Flight Path Intent Service (FLIPINT); 4-Dimensional Trajectory (4DT) in space (latitude, longitude, altitude) and time; message (Msg); Special Activities Airspace (SAA); Traffic Flow Management (TFM); Trajectory predictor (TP); Flight Information Region (FIR).

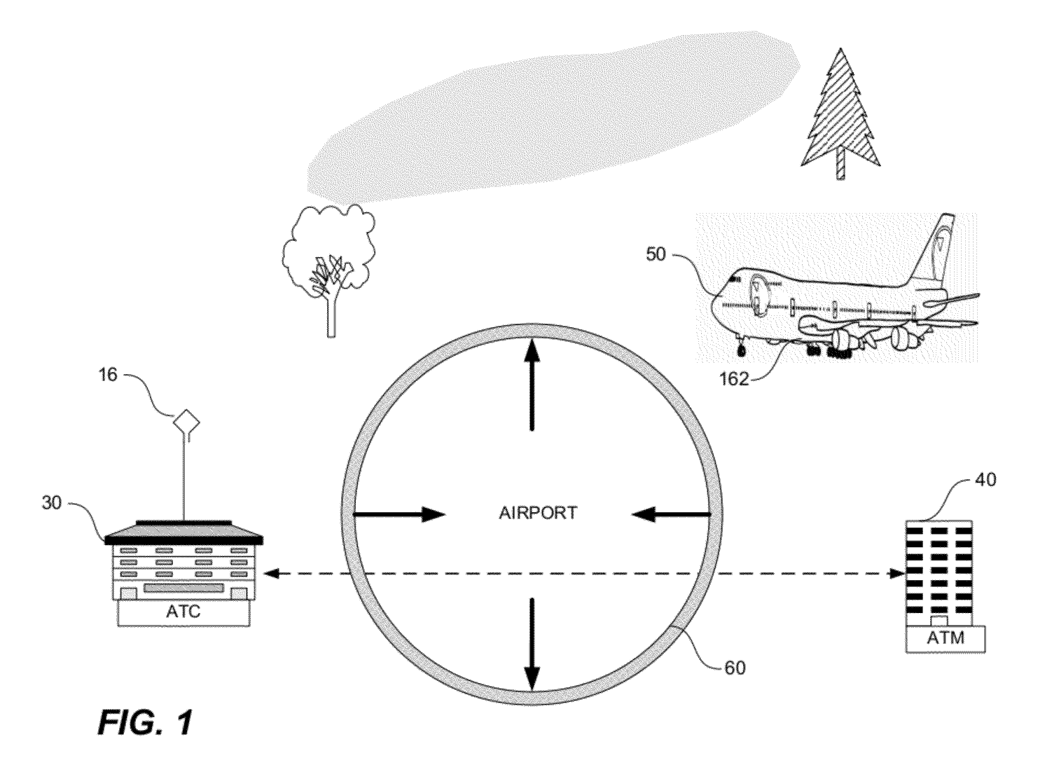

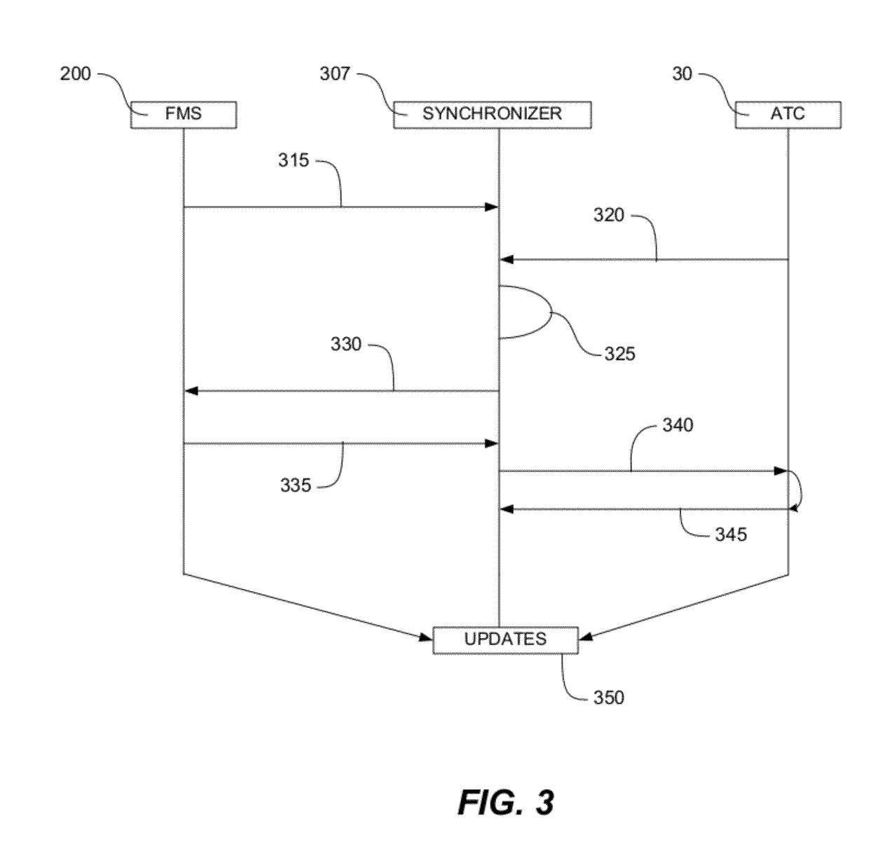

FIG. 1 illustrates a practical application to synchronize distinct trajectories in accordance to an embodiment. FIG. 1 diagrams the data collection, up-link/down-link, and trajectory synchronization of the invention. In a preferred embodiment, the invention predominantly uses existing equipment. For example, an aircraft 50 creates an aircraft trajectory which is saved in a memory storage location (not shown) in the aircraft or in an external location. A flight plan is made up of interlinked check points (or flight points). At each flight point, as far as the destination airport, the flight management system provides predictions: time of passage, speed, altitude, and fuel remaining on board. The aircraft trajectory is down-linked via an antenna 162 to a ground station such as ATC 30 and ATM 40 where the aircraft trajectory can be synchronized or processed to be synchronized with other trajectories as shown in FIG. 3. Communication with originating aircraft 50, other aircrafts, and other ground facilities is conducted via an up-link/down-link antenna 16. In an alternative embodiment, any communicative device, such as for example any electronic signal transmitting and receiving device, may be used that enables ATC 30 system to function as described herein.

The ground stations ATC 30 and ATM 40 could also communicate using a dedicated connection or through a network such as the interne. Additionally, Flight Information Regions (FIR) and terminal region data is provided by the ATC 30 and ATM 40, as part of the ATM data family, for different positions of the aircraft 50 relative to the airport 60. ATC 30 and ATM 40 comprise hardware and software that are well-known in the art. Both ATC and ATM 40 includes a processor that is communicatively coupled to graphical display interface and is programmed to generate and relay trajectory predictions, flight plans, ground traffic instructions to ground-based, taxiing aircraft, and other communication well known to those in the art. To enable processor to function as described herein, and in the exemplary embodiment, information, such as aircraft specification data and airport runway and/or taxiway maps, is provided to the processor. Moreover, data is provided to processor from surface ground radar systems, as well as data from aircraft-based Automatic Dependent Surveillance-Broadcast (ADS-B) systems. Alternatively, any applicable information, such as for example weather data from Automated Weather Observing System (AWOS) equipped units, may be provided to processor that may enable ATC system to function as described herein.

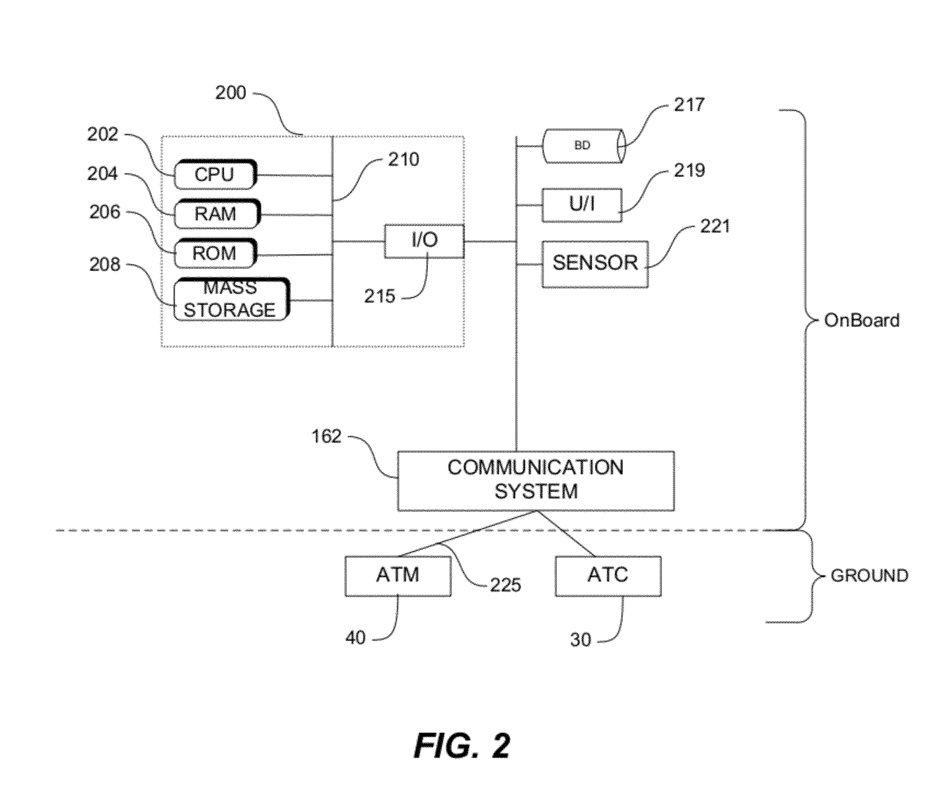

FIG. 2 is a block diagram of hardware and operating environment in which different embodiments can be practiced. An FMS computer 200, in aircraft 50, conventionally comprises a central processing unit 202 which communicates with an input-output interface 215, a program memory 206, a working memory 204, a data storage memory 206, and circuits 210 for transferring data between these various elements. The input-output interface is linked to various devices such as a user interface 219, a board display (BD) 217, sensors 221, and other items well known to those in the art. Programs instructions executable by the processor 202, specific to the aircraft are stored in the data memory 206. The program instructions are transferred to the working memory so as to produce an aircraft trajectory, to receive changes or messages with instructions as to changes, or to update the aircraft trajectory. The FMS computer 200 is linked to a ground/onboard communication system 162 which is in turn linked to ATC 30 and ATM 40 via a communication link such as a C/P-DLC digital link 225 or Automatic Dependent Surveillance-Contract (ADS-C) link.

FIG. 3 transaction flow diagram illustrating the manner in which the flight management system (FMS) 200 and ATC computer of FIG. 1 cooperate to perform trajectory synchronization and exchange of data relating to a flight plan trajectory in accordance to an embodiment. It should be noted that synchronizer 307 need not be separate and distinct from both FMS 200 and ATC 30. It is expected that synchronizer 307 would be in the same facility or it could be distributed between ATC 30 and FMS 200. It is likewise possible that synchronizer 307 is in a remote location and that data is being exchange through a communication channel such as a satellite network. The FMS 200 down-links to the synchronizer 307 an aircraft trajectory 315; the ATC 30 down links a ground trajectory 320 to the synchronizer 307; in step 325 verification of route agreement is made by comparing the aircraft trajectory 315 with the ground trajectory 320; in step 325 the synchronizer 307 does a verification of restriction compliance in the aircraft trajectory 315; the synchronizer 307 sends the FMS 200 instructions 330 to correct for discrepancies and violations detected in step 325; the FMS 200 applies the changes identified and generates 335 a four-dimensional trajectory (4DT) in space (latitude, longitude, altitude) and time; the 4DT is down linked to the synchronizer 307; The synchronizer in step 340 down links the 4DT to the ATC so as to provide the information needed on the ground for reconstruction of realistic alternative trajectories; in step 345, the ATC 30 builds a trajectory using the 4DT cusps which is uploaded to the synchronizer 307; a mechanism is maintained to continuously perform updates 360 so as to perform initial longitudinal (time)re-conformance, conformance monitoring, and wind synchronization which tend to change at least aircraft trajectory.

The trajectory comparison algorithm for step 325 should initially identifies differences in the 2D path as follows:

Identifies discrepancies in the 2D path between two trajectories
T1: trajectory 1; T2: trajectory 2

(i) Perpendicularly (or closest distance if perp. does not exist) project T1
cusps on T2 segments;
(ii) Perpendicularly (or closest distance if perp. does not exist) project T2
cusps on T1 segments;
(iii) Find E^{⊥} = the largest perpendicular separation distance between T1-
T2 (from previous steps);
If E^{⊥} < θ^{⊥}: trajectories are synchronized in the horizontal dimension
(θ^{⊥} = threshold)
Else, list of distances di > θ^{⊥} are identified discrepancies

In step 345, the ATC 30 builds a trajectory using the 4DT cusps using an algorithm to build the ground trajectory using FMS trajectory change points (TCP):

1. Build a new trajectory appending segments constructed from cusp location
(Latitude, Longitude), altitude and time equal to those copied from the FMS
TCP
2. If the estimated error in the initial ground speed of the segment is larger
than a threshold (determined based on error propagation) then set the
segment acceleration to zero and the speeds to their implied value.

| | |
|---|---|
| $\begin{matrix}{V}_{g} = \frac{L}{Δ T} \\ ROCD = \frac{Δ h}{Δ T}\end{matrix}$ | where, V_{g} = ground speed L = segment length Δh = altitude change inside the segment ΔT = segment duration ROCD = rate of climb or descent |

3. Else, compute segment acceleration constrained to leave cusp times
unchanged:

| | |
|---|---|
| $\begin{matrix}{v}_{0} = {v}_{w} + {v}_{TAS} \\ a = 2 \frac{L - {v}_{0} Δ T}{Δ {T}^{2}}\end{matrix}$ | where a = acceleration L = segment length (along route distance) v0 = computed ground speed at the start of the segment vTAS = FMS speed (Mach or CAS) that applies to the start of the segment vw = component of wind velocity vector along the direction of the segment ΔT = segment duration |

The Algorithm to build the ground trajectory using FMS trajectory change points (TCP) Thresholds & Errors can be express as follows:

1. In the zero acceleration assumption (constant implied speed) case, there
will be longitudinal errors that reach a maximum near the segment mid point
(by construction segment end points are constrained by TCPs). The errors
are present if the real acceleration (a) in the segment is not null.*
VTAS and ROCD changes value during a constant Mach/CAS descent
or climb segment
By construction, cross-track errors are not expected (except for minor
distortion due to WGS84 geodesics vs. spherical earth modeling or
differences in the details of how turns are represented in the two systems)
The maximum longitudinal error grows with segment duration (ΔT):
${ɛ}_{x} = \frac{a}{8} Δ {T}^{2} a = ground acceleration {(}^{*} )$ ${(}^{*} ) assumed to be null in the model \text{,} but non \text{-} zero in actuality .$
2. Maximum longitudinal errors in the second case (implied constant
acceleration) due to jerk (the error arises due to assuming constant
acceleration when in reality it is not):
${ɛ}_{x} = \frac{2 b}{81} Δ {T}^{3} b = {x}^{...} ( 3 rd time derivative or jerk )$
3. Longitudinal errors in the second case (implied constant acceleration) due
variance in v0:
${ɛ}_{x} = ( \frac{Δ T}{4} ) {σ}_{v}$ ${σ}_{v} = error ( standard deviation ) in speed at start of the segment ( {v}_{0} )$

The disclosed embodiments may concern synchronizing the distinct trajectories predicted by the aircraft Flight Management System (FMS), the ground Air-Traffic Control (ATC) system and other Air Traffic Management (ATM) systems. Previous trajectory synchronization approaches can be classified according to the type of data that is exchanged such as (a) Flight Intent, (b) Aircraft Intent (Al), (c) Behavior Model, or

(d) Predicted Trajectory. Flight intent may primarily be the information carried by the flight plan (FP) but it is insufficient for accurate synchronization because it does not contain enough information to build from it an unambiguous rendition of the flight path in four dimensions (4D) (i.e., multiple dissimilar trajectories can be generated from the same flight plan). Some attempts have been made to improve the near-range estimation capability of the ground-based systems based solely on the flight intent and tracking information, but more accurate levels of synchronization are achievable with better air-ground information exchange.

Aircraft intent-based trajectory synchronization may rely on using the FMS provided AI that specifies the guidance modes and control instructions needed to build the 4D trajectory that executes the flight plan. However, often times the ground system has more information than the FMS (i.e. restrictions and background traffic) and needs to work with a trajectory that reflects all of the knowledge available by the ground system; secondly, even though two trajectory predictors can start with the same AI inputs, differences in weather forecast models and aircraft performance models could result in significantly different 4D predictions.

The amount of AI data that must be exchanged to synchronize trajectories may also be prohibitive using existing data links. Similar drawbacks affect the recently proposed exchange of behavior model (i.e. list of maneuvers required to execute the flight plan) as a means for trajectory synchronization. The fourth synchronization approach, consisting of downlinking the FMS predicted 4D-trajectory and using it “as is” by the ground systems has the advantage that it may encode user preferences. However, this approach is limited by the fact that the FMS 4D-trajectory is a prediction for current conditions and constraints (flight points or trajectory change points) only, and if conditions change in the ground that require building alternative trajectories the FMS 4D-trajectory has to be discarded and a completely new trajectory has to be built in the ground, opening the possibility for breaking synchronization.

The disclosed embodiments may provide a process for trajectory synchronization based on sequential stages coordinated by the ground service provider (for instance ATC or traffic flow managers). The following stages may describe the process for air-ground trajectory synchronization only (a similar process is used for ground-ground trajectory synchronization):

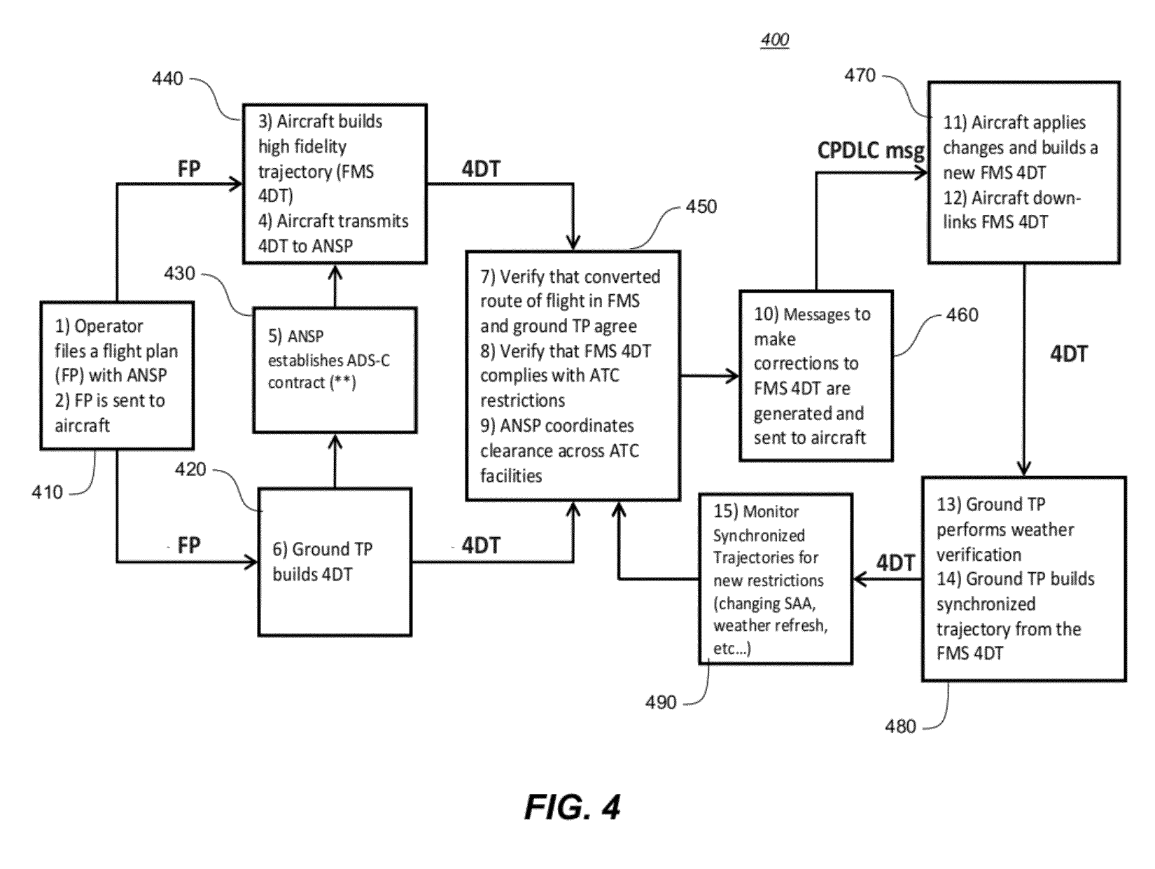

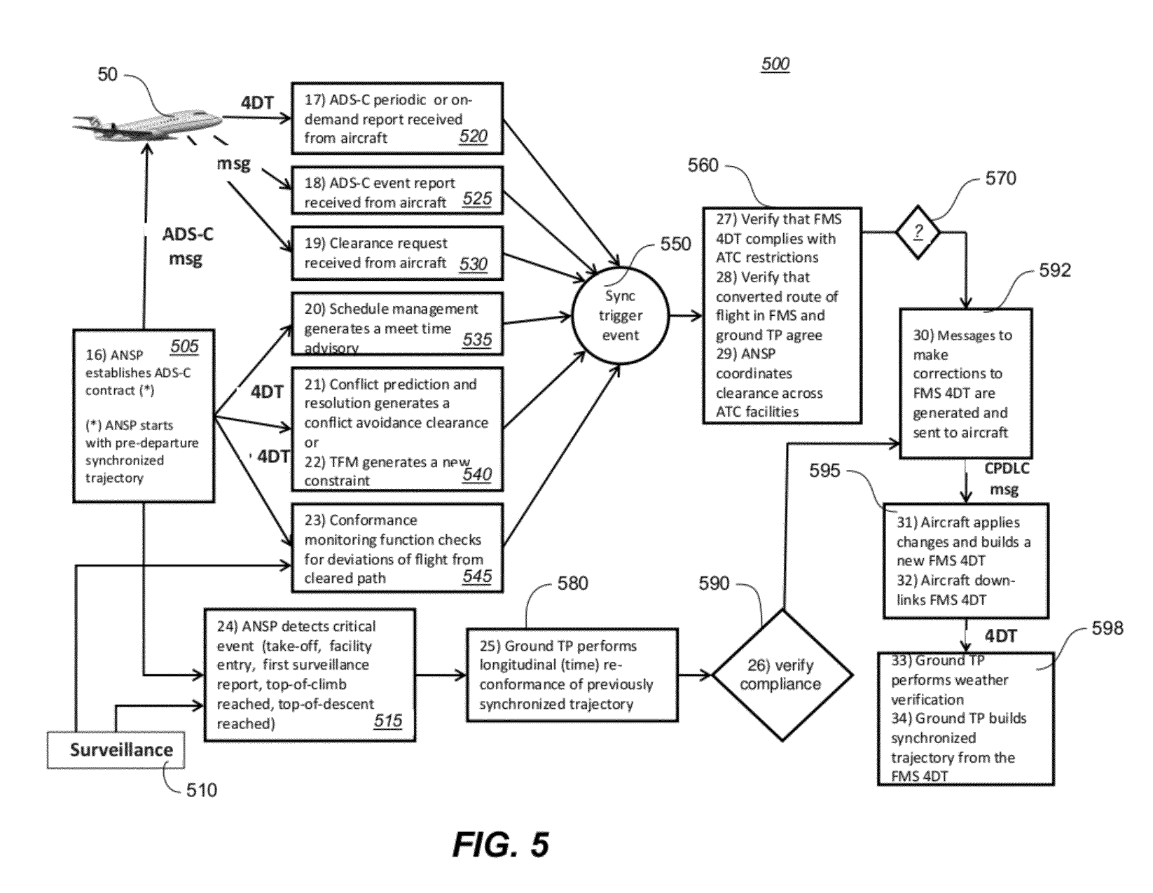

In FIG. 4 and FIG. 5 the trajectory synchronization will be described using method language which is customarily found with reference to a flowchart that enables one skilled in the art to develop such programs, firmware, or hardware, including such instructions to carry out the methods on suitable computers, executing the instructions from computer-readable media. Therefore, although described in procedural terms, one of ordinary skill in the art will appreciate that implementations can be made using hardware components or any other design environment that provides the required relationships.

FIG. 4 is a block diagram of a pre-departure trajectory synchronization in accordance to an embodiment.

A. Pre-Departure/Pre-Flight Information Region (FIR) Crossing Phase:

In step 410, an initial trajectory request: upon reception of the flight plan (FP) by the ground system and having reached a time which is a parameter number of minutes before the estimated departure time (if the flight is internal to the facility or the extended facility—i.e. the NAS—) or before the FIR crossing the ground system issues a trajectory request (TR) to the air system; the FMS trajectory may be down-linked to the ATC system. In step 420, ground TP builds 4DT from the FP. In step 430 the ANSP establishes ADS-C contract from in order to automatically obtain the 4DT objects created in the FMS. In step 440 the aircraft 50 builds a high fidelity trajectory from the FP and makes it available via ADS-C downlink to the ground systems. In step 450, the high fidelity trajectory of step 440 and the 4DT from the ground TP are verified.

In step 450 verification of route agreement is made by comparing the FMS trajectory with the ground trajectory in order to detect discrepancies in the latitude and longitude information that defines the 2D route. Trajectory comparison is done by a computer executing instructions that perform cusp-to-cusp differencing consisting of the following steps:

(i) Selecting a portion (or one or more portions) of trajectory where synchronization is desired (the complete trajectory may not be subject to synchronization, for instance if the flight is leaving the controlled airspace); (ii) Calling T1 the FMS trajectory, calling T2 the ground trajectory; (iii) Traversing T1 in cusp order, for each cusp perpendicularly project the 2D position of the cusp on T2 (if there is no perpendicular projection then selecting the nearest point as the ‘projection’ point); (iv) Computing the 2D distance between the cusp and the projection point;
(a) If the distance is greater than a threshold, then flagging this cusp as discrepant;
(b) Repeating for all cusps of T1;
(c.) Repeating the above steps but his time traversing T2;
(d) Reporting the discrepant cusps.

Further in step 450, verification of restriction compliance is made by insuring that the FMS trajectory (aircraft trajectory) complies with altitude and speed restrictions.

In step 460, instructions are assembled in order to correct for discrepancies detected in step 450 and restriction violations identified in step in step 450; this instructions may be communicated to the operator (pilot or Airline Operations Control Center AOCC) via established air-ground communication systems such as CPDLC.

In step 470, the FMS system applies the changes identified in step 460 and produces a new FMS 4DT. This new 4DT is pushed to the ground system for processing. The air system down link the FMS trajectory to the ground system.

In step 480, the ground receives from the aircraft (FMS) a four-dimensional trajectory (4DT) in space (latitude, longitude, altitude) and time. Given that the main sources of discrepancies expected between the FMS-generated trajectory and the ATC-generated trajectory may be the rates of change in the altitude and speed during takeoff, initial climb, descent, final approach and landing (i.e. the vertical profile), the downlink of the aircraft 4DT may provide the information needed on the ground for reconstruction of realistic alternative trajectories, if needed.

Continuing with step 480, the ground system may build a trajectory using FMS trajectory cusps. An approach to build the synchronized ground trajectory may be to insert cusps with the same geographic location, altitudes and times as those found in the FMS trajectory; two alternatives may be used to set the speeds and accelerations, depending on the available data in the FMS trajectory: The ground computers in the ATC perform the following instructions to build a synchronized trajectory:

(1) Approximate the segments to be of constant speed as implied by the segment length and duration (the effective average ground speed is equal to the segment length divided by the segment duration); and
(2) Compute the acceleration based on the point and wind velocities provided in the FMS trajectory (for instance as specified in the ARINC® 702A standard). For each trajectory segment that is being built the acceleration a can be derived, assuming that it is constant, using the true air speed (TAS) at the beginning of the segment, the wind speed, the duration of the segment T and the length of the segment L: a=2*(L−v*T)/(T*T), where v is the ground speed computed as the vector sum of the true air speed and wind speed; alternatively (because the system is over-determined) the acceleration can be directly computed using the ground speed at the beginning of the segment v0, the ground speed at the end of the segment v1 and the duration of the segment T: a=(v1−v0)/T. If the acceleration is truly constant then these two are equivalent. The errors involved in these two approaches may depend on segment duration, therefore means should be provided to allow in step (d) above for the insertion of additional trajectory points (arbitrary Lat/Lon points) so that long segments in the FMS trajectory can be broken into smaller ones to maintain the required fidelity. Longitudinal prediction errors may grow with time and may have adverse effects in functions (such as conflict probe) that depend on trajectories, therefore: accuracy requirements for these functions may dictate the maximum tolerances allowed and in turn the maximum segment length. Segment duration T (or equivalent segment length) can be controlled to limit the size of the discrepancies between the ground trajectory and the FMS trajectory, specifically the maximum longitudinal error within a segment due to non-zero acceleration (b=change of acceleration within the segment) is equal to error=2*b*T*T*T/81; the maximum longitudinal error in a segment due to uncertainty in the air speed at the start of the segment (sv) is error=sv*T/4; the maximum ground speed error due to assuming constant acceleration when in reality it is not constant is error=b*T*T/6; similarly the error in altitude due to vertical acceleration (ah) is error=ah*T*T/8, T is segment duration.

The steps described below apply for trajectories that have already passed the first synchronization stage:

In step 490, the trajectories are kept current, fresh, or updated through an updating module that performs the following steps: Initial longitudinal (time) re-conformance: as soon as the ground systems receive a departure or FIR crossing message, the ground trajectory may be longitudinally re-conformed (cusp times may be recomputed to be consistent with time information provided). (i) Conformance monitoring: as the flight progresses, a number of situations may arise that result in loss of synchronization (for instance: change in runway assignment, unforeseen wind changes, errors in wind forecast, tactical intervention by the controller, weather reroutes, velocity variance due to cost index, etc.). For this reason, it may be necessary that the ground system checks the sensed position reports provided by the surveillance system against the active trajectory and in cases of out of conformance detections, corrections may be applied to the active trajectory; this operation may entail a re-synch process consisting of the steps a through g above. Updating as a result of wind related forces.

In step 490, trajectory synchronization is needed to compensate for wind conditions. Air-ground wind model discrepancies may potentially be an additional source of significant errors leading to two type of problems: (1) a synchronized trajectory going out of conformance repeatedly in short time intervals, thus triggering multiple re-synch operations, and (2) an aircraft flying a conflict free synchronized trajectory encountering a real conflict (unpredicted because of wind discrepancies) in the future that will cause tactical intervention and thus nullify the benefits of synchronization (and possibly even introduce penalties). Errors in wind data and discrepancies in wind models between air-ground systems may result in longitudinal errors (sₓ) that grow with prediction time (T) as sₓ=T sᵥ, where sᵥ=ground speed error and could become a significant source of error. Discrepancies in wind forecasts may result in invalid conflict probe predictions. Using FMS wind data in the ground system may not be an option because conflict predictions of neighboring aircraft using different wind data would result in false or missed alerts. Conflict probe may require the wind model to be consistently applied to all aircraft. If the wind data used by the FMS is made available as part of the FMS trajectory down-link (as provided in the ARINC® 702A specification), the ground system may check for consistency of wind models. If in addition to the FMS wind data there is also a wind model age (time since forecast was computed) or wind accuracy (figure of merit) information, the ground system may assess the reliability of the wind data used by the FMS. Accordingly, if the ground systems deems that the wind data used by the FMS is stale or unreliable then the ground system may up-link new wind data to the aircraft to be used by the wind blending algorithms in the FMS; on the other hand if the wind data in the FMS is “fresh” and if there is a significant discrepancy (i.e. large relative to intrinsic wind models errors), then the ground system may add prediction buffers to account for larger prediction errors (conflict probe, for instance, can be performed adding a buffer to accommodate the uncertainty in speed).

The disclosed embodiments meet the need in the art to provide a solution to the problems of conventional systems for the following reasons:

(a) The disclosed embodiments may take into account user preferences: by using the (restriction compliant and laterally synchronized) down-linked FMS trajectory to build the ground trajectory all of the optimization choices made by the FMS to build its own trajectory, may be automatically incorporated in the ground system (for instance if the FMS modeled an optimized descent, the vertical profile in the ground system may reflect such optimization).
(b) By exchanging a combination of aircraft intent (AI) data and trajectory data, the disclosed embodiments may solve the problems associated with the individual limitations associated with each one of these data items (as described in the previous item).
(c) The trajectory synchronization of the disclosed embodiments may be highly dynamic and thus allows for required adjustments that arise in realistic situations.
(d) The disclosed embodiments may build on current or planned technologies and concepts (CPDLC, data comm., ARINC 702A, RTCA SC-214, etc), and may thus allow for an initial implementation in a mixed equipage environment and a smooth evolution of the ATC system towards TBO.

FIG. 5 is a block diagram of a in-flight trajectory synchronization in accordance to an embodiment. In action 505, ANSP establishes ADS-C contract wherein ANSP starts with pre-departure synchronized trajectory.

In action 510, surveillance data may also be captured to aid in trajectory creation.

In action 515, ANSP detects critical event (take-off, facility entry, first surveillance report, top-of-climb reached, top-of-descent reached).

The information from action 515 is then used by action 580 so that ground TP can perform longitudinal (time) re-conformance of previously synchronized trajectory. In action 590, the re-conformance is used to verify compliance of trajectories. The result of the verification is sent to action 592 for further processing.

The initial trajectory, action 505, is sent from the aircraft 50 in accordance with the ADS-C contract request, other ground automation components that use the trajectory (action 535-545), and Air Traffic Service Provider (action 515).

The aircraft 50 performs processing of the initial trajectory to produce 4DT ADS-C periodic or on-demand report (Action 520), ADS-C event report (step 525), and clearance request (step 530).

In step 535, the initial trajectory is used by a schedule management module to generate a meet time advisory.

In step 540, the initial trajectory is used by a conflict prediction and resolution module to generate a conflict avoidance clearance or by a TFM to generate a new constraint.

In step 545, the initial trajectory is used by a conformance monitoring function checks for deviations of flight from cleared path.

Steps 520, 525, 530, 535, 540, 545 are processed in step 550 to determine a sync trigger event. If a sync triggering event is discovered in step 560 control is passed to action 560 for further processing.

In step 560, Verify that FMS 4DT complies with ATC restrictions, verify that converted route of flight in FMS and ground TP agree, and ANSP coordinates clearance across ATC facilities. If the discrepancies are discovered in step 560 and 570 a message is generated requesting modification of the trajectory. Step 592 a messages to make corrections to FMS 4DT are generated and sent to aircraft in the event of discrepancies (step 560) or failure to verify compliance (step 590).

In step 595, aircraft 50 applies changes and builds a new FMS 4DT and Aircraft 50 down-links FMS 4DT. In action 598, ground TP performs weather verification and ground TP builds synchronized trajectory from the FMS 4DT.

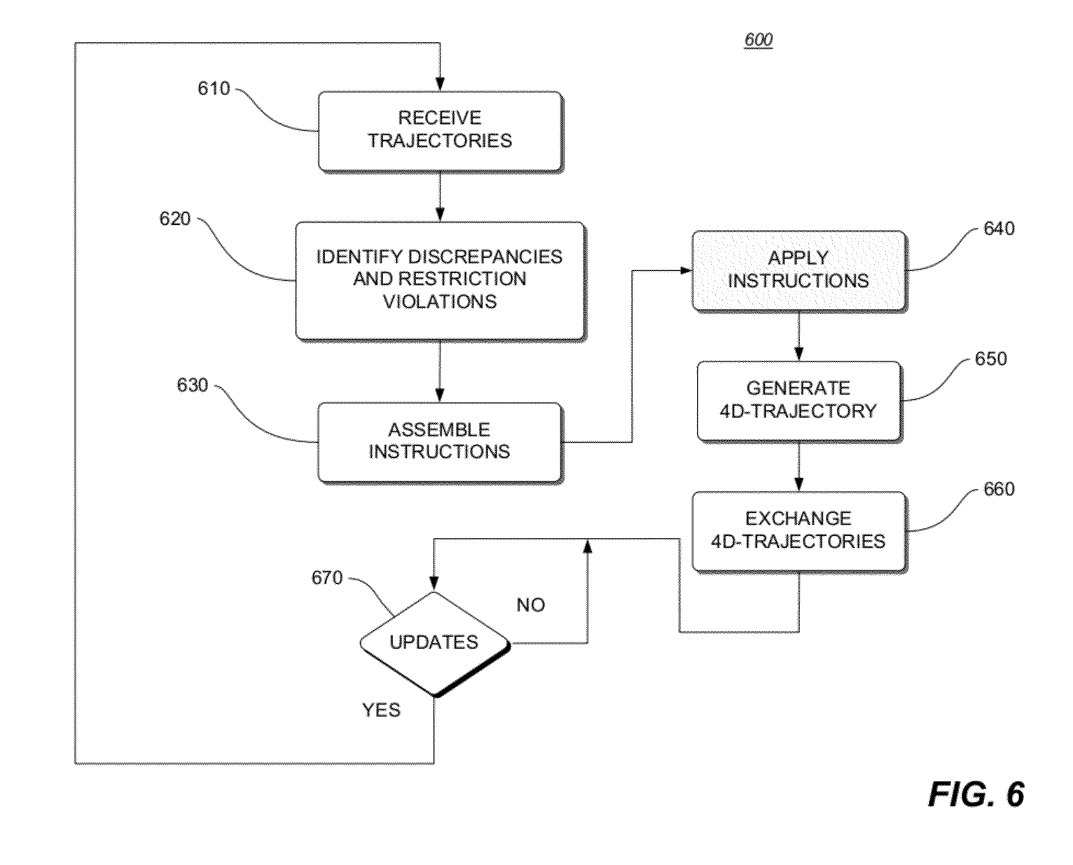

FIG. 6 is a flowchart of a method for trajectory synchronization in accordance to an embodiment. Method 600 begins with step 610 where the trajectory synchronization module/system receives trajectories from and FMS and ATC. The method in step 620 identifies discrepancies and restriction violations from the received trajectories. A discovered discrepancy or violation from step 620 causes the method to assemble and generate instructions in step 630. In action 640, instructions are applied and a new trajectory is created that remedy the discrepancies. In action 650, a 4D-trajectory (4DT) is generated. The generated trajectory from step is propagated to or exchange with other systems (ATC, ATM, and etcetera) in step 660. The method waits for updates (triggering events) that would require changes to the 4DT of step 660. The Updates of step 670 are sent to 610 for further processing in accordance to method 600.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the disclosure are part of the scope of this disclosure. For example, the principles of the disclosure may be applied to each individual user where each user may individually deploy such a system. This enables each user to utilize the benefits of the disclosure even if any one of the large number of possible applications do not need the functionality described herein. In other words, there may be multiple instances of the components each processing the content in various possible ways. It does not necessarily need to be one system used by all end users. Accordingly, the appended claims and their legal equivalents should only define the disclosure, rather than any specific examples given.

The attached materials provide further details of the disclosure, as set forth below:

What is claimed is:

1. A method for trajectory synchronization comprising:
receiving an aircraft trajectory from a first system and a ground trajectory from a second system comprising a series of points associated with various flight points or trajectory change points for an aircraft;
comparing the aircraft trajectory and the ground trajectory to detect discrepancies;
verifying from the aircraft trajectory that a proposed flight plan complies with at least one aircraft restriction; and
if there are identified discrepancies and restriction violations from the comparing and the verifying of the aircraft trajectory and the ground trajectory sending a message to the first system with instruction for correcting.

2. The method in accordance to claim 1, the method further comprising:
receiving from the first system a four-dimensional (4D) trajectory comprising correction of the identified discrepancies and restriction violations.

3. The method in accordance to claim 2, the method further comprising:
receiving an updated ground trajectory after processing of the four-dimensional trajectory from the first system by the second system and generating a new synchronized trajectory to be used in the ground system by using the TCP attributes (Latitude, Longitude, Altitude, Speed and time) obtained from the 4D trajectory built in the first system.

4. The method in accordance to claim 3, the method further comprising:
reconforming the updated ground trajectory if the aircraft has received a departure message or if a sector crossing message has been received at the first or second systems.

5. The method in accordance to claim 4, the method further comprising:
monitoring and updating the updated ground trajectory and the aircraft trajectory based on information pertaining to at least one of ground changes, change in environmental conditions.

6. The method in accordance to claim 5, wherein comparing the aircraft trajectory and the ground trajectory to detect discrepancies is based on detecting discrepancies in latitude and longitude information.

7. The method in accordance to claim 6, wherein comparing is achieved with a cusp-to-cusp differencing algorithm.

8. The method in accordance to claim 7, wherein at least one aircraft restriction is selected from the group consisting of altitude restriction and speed restriction.

9. A system for synchronizing distinct trajectories in airspace, the system comprising:
a computer executing an interface to receiving an aircraft trajectory from a first system and a ground trajectory from a second system comprising a series of points associated with various flight points or trajectory change points for an aircraft; and
a processor and a memory coupled to the processor, wherein the memory comprises program instructions executable by the processor to:
comparing the aircraft trajectory and the ground trajectory to detect discrepancies;
verifying from the aircraft trajectory that a proposed flight plan complies with at least one aircraft restriction;
wherein the computer executes a notification manager if there are identified discrepancies and restriction violations from the comparing and the verifying of the aircraft trajectory and the ground trajectory to send a message to the first system with instruction for correcting identified discrepancies restriction violations.

10. The system in accordance to claim 9, wherein the interface further receiving from the first system a four-dimensional (4D) trajectory comprising correction of the identified discrepancies and restriction violations.

11. The system in accordance to claim 10, wherein the interface further receiving an updated ground trajectory after processing of the four-dimensional trajectory from the first system by the second system and generating a new synchronized trajectory to be used in the ground system by using the TCP attributes (Latitude, Longitude, Altitude, Speed and time) obtained from the 4D trajectory built in the first system.

12. The system in accordance to claim 11, the processor further performing
reconforming the updated ground trajectory if the aircraft has received a departure message or if the aircraft has received a flight information crossing message.

13. The system in accordance to claim 12, the processor further performing
a monitoring and updating the updated ground trajectory and the aircraft trajectory based on information pertaining to at least one of ground changes, change in environmental conditions.

14. The system in accordance to claim 13, wherein comparing the aircraft trajectory and the ground trajectory to identified discrepancies is based on detecting discrepancies in latitude and longitude information.

15. The system in accordance to claim 14, wherein comparing is achieved with a cusp-to-cusp differencing algorithm.

16. The system in accordance to claim 15, wherein at least one aircraft restriction is selected from the group consisting of altitude restriction and speed restriction.

17. The system in accordance to claim 16, wherein the first system and the second system is selected from a group consisting of a flight management system, air-traffic control system, and air traffic management systems.

18. A non-transitory computer-readable medium having instructions that when compiled by a processor perform trajectory synchronization from a plurality of systems comprising:
a computer-usable data carrier storing instructions, the instructions when executed by a computer causing the computer to perform trajectory synchronization by:
comparing the trajectories to verify at least one route agreement for an aircraft;
verifying from the trajectories that a proposed flight plan complies with at least one aircraft restriction; and
sending a message to at least one of the plurality of systems with instruction for correcting identified discrepancies and restriction violations from the verifying and the comparing of the trajectories.

19. The non-transitory computer-readable medium of claim 18, wherein comparing is achieved with a cusp-to-cusp differencing algorithm.

20. The non-transitory computer-readable medium of claim 19, wherein the instructions further comprise instructions causing the computer to receive from one of the plurality of systems a four-dimensional (4D) trajectory comprising correction of the identified discrepancies and restriction violations.

21. The non-transitory computer-readable medium of claim 20, wherein comparing the aircraft trajectory and the ground trajectory to identified discrepancies is based on detecting discrepancies in latitude and longitude information.

22. The non-transitory computer-readable medium of claim 21, wherein at least one aircraft restriction is selected from the group consisting of altitude restriction and speed restriction.

23. The non-transitory computer-readable medium of claim 22, wherein the instructions further comprise instructions to monitor and updating the updated ground trajectory and the aircraft trajectory based on information pertaining to at least one of ground changes, change in environmental conditions.
